(19) United States
(12) Patent Application Publication
(10) Pub. No.: US 2016/0292402 A1
(43) Pub. Date: Oct. 6, 2016

(54) PASSWORD INPUT METHOD AND SYSTEM BASED ON TWO-STAGE CONVERSION

(71) Applicant: Yongpeng SANG, Wuhan, Hubei (CN)

(72) Inventor: Yongpeng SANG, Wuhan, Hubei (CN)

(21) Appl. No.: 14/913,211

(22) PCT Filed: Feb. 11, 2015
(86) PCT No.: PCT/CN2015/072711

§ 371 Date: Feb. 19, 2016

(30) Foreign Application Priority Data
Oct. 13, 2014 (CN) 201410537714.6

(51) Int. Cl. G06F 21/31; G06F 21/83

(52) U.S. Cl. CPC G06F 21/31; G06F 21/83

(57) ABSTRACT

The invention discloses a password input method based on two-stage conversion. The method specifically includes that (1) password composition symbols are used as original basic symbols, and middle basic symbols are randomly selected for the original basic symbols; (2) the original basic symbols and the middle basic symbols are randomly ordered respectively and are in one-to-one correspondence according to spatial position relation to form first-stage correlation; (3) the original basic symbols and the middle basic symbols are randomly ordered again respectively and are in one-to-one correspondence according to spatial position relation to form second-stage correlation; (4) as for current to-be-input password composition symbols, the original basic symbols which the current to-be-input password composition symbols correspond to are inquired according to the second-stage correlation and then the first-stage correlation so that input operation of the current to-be-input password composition symbols can be finished; (5) steps of (2)-(4) are repeated till input of all password composition symbols is finished. By means of the password input method based on two-stage conversion, the method can be excellently adapted to currently widely used password input environments, meanwhile, the problem of password stealing can be effectively avoided, and safety during password input can be improved.

### FIELD OF THE INVENTION

The invention relates to the field of computer information security, and more particularly to a password input method and system based on two-stage association.

### BACKGROUND OF THE INVENTION

In conventional password authentication systems, passwords in the format of alphabets, numbers, or combinations thereof are submitted to the systems or someone else for authentication. However, there is a problem with the conventional password authentication systems: for security reasons, the systems require users use strong passwords (such as combinations of capital/small letters, numbers and some special characters) that take up large space and thus are not easily to be decrypted. In contrast, for usage and memory reasons, users are prone to use comparatively short or familiar passwords, and thus bringing about a fatal security problem: it is possible for hackers to decrypt the passwords of the users and to steal information thereof by brute force attack, dictionary attack and so on. D. Klein pointed out that it is possible to crack ¼ of 14000 passwords by using a dictionary containing 3000000 words, and E. Spafford stated that passwords of half of existing websites can be decrypted by using 1988 UNIX-based online dictionaries and 432 words. In addition, as processing speeds of modern computers significantly increase, more complex and advanced attack dictionaries can be used for easily decrypting or hacking passwords, and correspondingly, decryption speeds thereof become higher than before.

### SUMMARY OF THE INVENTION

In view of the above-mentioned problems, it is an objective of the invention to provide a password input method and system based on two-stage association capable of effectively preventing stealing and decryption of passwords by creating an intermediate symbol between an password symbol and an input symbol so that the input symbol is not simply corresponding to the password symbol, and enabling a user to input a symbol according to an association relationship therebetween instead of an original symbol.

To achieve the above objective, in accordance with one embodiment of the invention, there is provided a password input method based on two-stage association, comprising:

(1) providing multiple password symbols as original symbols, and randomly creating intermediate symbols with the same number therewith;

(2) randomly ordering the original symbols and the intermediate symbols, and associating each ordered original symbol with respective ordered intermediate symbol based on spatial positions thereof, thereby creating first-stage association relationship;

(3) randomly re-ordering the original symbols and the intermediate symbols, and re-associating each re-ordered original symbol with respective re-ordered intermediate symbol based on spatial positions thereof, thereby creating second-stage association relationship;

(4) inputting a current password symbol by firstly searching for an intermediate symbol corresponding thereto in the second-stage association relationship, obtaining an original symbol corresponding to the intermediate symbol in the first-stage association relationship, and inputting the obtained original symbol; and

(5) repeating steps (2) to (4) until input of all password symbols is completed.

In a class of this embodiment, the original symbol is one of an alphabet, a number, a special character, a Chinese character, a graph, an image, or a combination thereof.

In a class of this embodiment, the intermediate symbol is one of an alphabet, a number, a special character, a Chinese character, a graph, an image, or a combination thereof

In a class of this embodiment, the original symbol is different from the intermediate symbol.

In a class of this embodiment, the original symbol is an alphabet, a number, or a combination thereof, and the intermediate symbol is a special character, a graph, an image, or a combination thereof

In a class of this embodiment, each of the first-stage association relationship and the second-stage association relationship is formed in a manner of a sequence or a matrix.

In accordance with another embodiment of the invention, there is provided a password input system based on two-stage association, comprising:

a first module configured to provide multiple password symbols as original symbols, and to randomly create intermediate symbols with the same number therewith;

a second module configured to randomly order the original symbols and the intermediate symbols, and to associate each ordered original symbol with respective ordered intermediate symbol based on spatial positions thereof, thereby creating first-stage association relationship;

a third module configured to randomly re-order the original symbols and the intermediate symbols, and to re-associate each re-ordered original symbol with respective re-ordered intermediate symbol based on spatial positions thereof, thereby creating second-stage association relationship;

a fourth module configured to input a current password symbol by firstly searching for an intermediate symbol corresponding thereto in the second-stage association relationship, to obtain an original symbol corresponding to the intermediate symbol in the first-stage association relationship, and to input the obtained original symbol; and

a fifth module configured to repeat the second modules to the fourth modules, until input of all password symbols is completed

Advantages of the invention comprise:

1) by adding the intermediate symbol between the password symbol and the input symbol, and by creating the first-stage association relationship between the original symbol and the intermediate symbol, as well as the second-stage association relationship between the intermediate symbol and the original symbol, input symbols finally input by a user is determined by the association relationships, every time a user inputs a different password symbol, the association relationship varies, and it is very difficult for people other than a user himself to remember. Therefore, for a given user password, symbols that are finally input by a user may be a combination of different symbols, which makes it possible to prevent stealing of the password. 2) a conventional password input method is changed by introducing the randomly generated association relationship, which significantly improves security of the password input.

### BRIEF DESCRIPTION OF THE ACCOMPANYING DRAWINGS

FIG. 1 is a flow chart of a password input method based on two-stage association of an exemplary embodiment of the invention;

FIG. 2 illustrates a first example of the invention, in which FIG. 2(a) illustrates a keyboard of an ATM machine in the first example, FIG. 2(b) illustrates an intermediate symbol used in the first example, FIGS. 2(c) and 2(d) illustrate a first-stage association relationship in the first example, and FIGS. 2(e) and 2(f) illustrate a second-stage association relationship in the first example;

FIG. 3 illustrates a second example of the invention, in which FIG. 3(a) illustrates a keyboard of an ATM machine in the second example, FIG. 3(b) illustrates an intermediate symbol used in the second example, FIG. 3(c) illustrates a first-stage association relationship in the second example, and FIG. 3(d) illustrates a second-stage association relationship in the second example; and

FIG. 4 illustrates a third example of the invention, in which FIG. 4(a) illustrates a keyboard of an ATM machine in the third example, FIG. 4(b) illustrates an intermediate symbol used in the third example, FIG. 4(c) illustrates a first-stage association relationship in the third example, and FIG. 4(d) illustrates a second-stage association relationship in the third example;

### SPECIFIC EMBODIMENTS OF THE INVENTION

For clear understanding of the objectives, features and advantages of the invention, detailed description of the invention will be given below in conjunction with accompanying drawings and specific embodiments. It should be noted that the embodiments are only meant to explain the invention, and not to limit the scope of the invention.

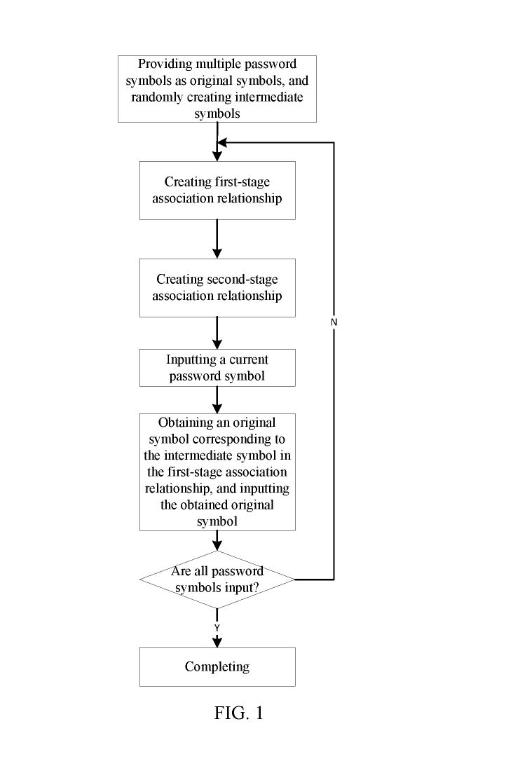

As shown in FIG. 1, a password input method based on two-stage association of the invention comprises steps of:

(1) providing multiple password symbols as original symbols, and randomly creating intermediate symbols with the same number therewith;

(2) randomly ordering the original symbols and the intermediate symbols, and associating each ordered original symbol with respective ordered intermediate symbol based on spatial positions thereof, thereby creating first-stage association relationship;

(3) randomly re-ordering the original symbols and the intermediate symbols, and re-associating each re-ordered original symbol with respective re-ordered intermediate symbol based on spatial positions thereof, thereby creating second-stage association relationship;

(4) inputting a current password symbol by firstly searching for an intermediate symbol corresponding thereto in the second-stage association relationship, obtaining an original symbol corresponding to the intermediate symbol in the first-stage association relationship, and inputting the obtained original symbol; and

(5) repeating steps (2) to (4) until input of all password symbols is completed.

Parsing of all password symbols input by the user is an inverse process of the above-mentioned password input method, and comprises determining final original symbols according to the first-stage association relationship and the second-stage association relationship.

The original symbol is one of an alphabet, a number, a special character, a Chinese character, a graph, an image, or a combination thereof

The intermediate symbol is one of an alphabet, a number, a special character, a Chinese character, a graph, an image, or a combination thereof

The alphabet is an English alphabet, a Latin alphabet, a Greek alphabet or so on.

The number is 0, 1, 2, 3 or so on.

The special character is a punctuation mark, a mathematical operator, a tab or so on.

The graph can be any visual graph such as a rectangle, a diamond, a triangle, a circular or so on.

The image can be an image of a human body or a part thereof, an image of a natural object such as a mountain, water, a tree, an animal or so on, or an image of a man-made image such as a vehicle, a boat, a plane, a desk, a chair or so on.

Preferably, the original symbol is different from the intermediate symbol.

Preferably, the original symbol is an alphabet, a number, or a combination thereof, and the intermediate symbol is a special character, a graph, an image, or a combination thereof

Preferably, each of the first-stage association relationship and the second-stage association relationship is formed in a manner of a sequence or a matrix.

It should be noted that the invention should not be limited to the two-stage association relationship, and three-stage, four-stage or multi-stage relationship can also be used. The more the number of stages is used, the higher complexity and security level the invention may have.

The method of the invention can be used in a wide variety of password applications, such as ATM machines, network banking, access control, file encryption systems, E-mail boxes and so on.

### Example 1

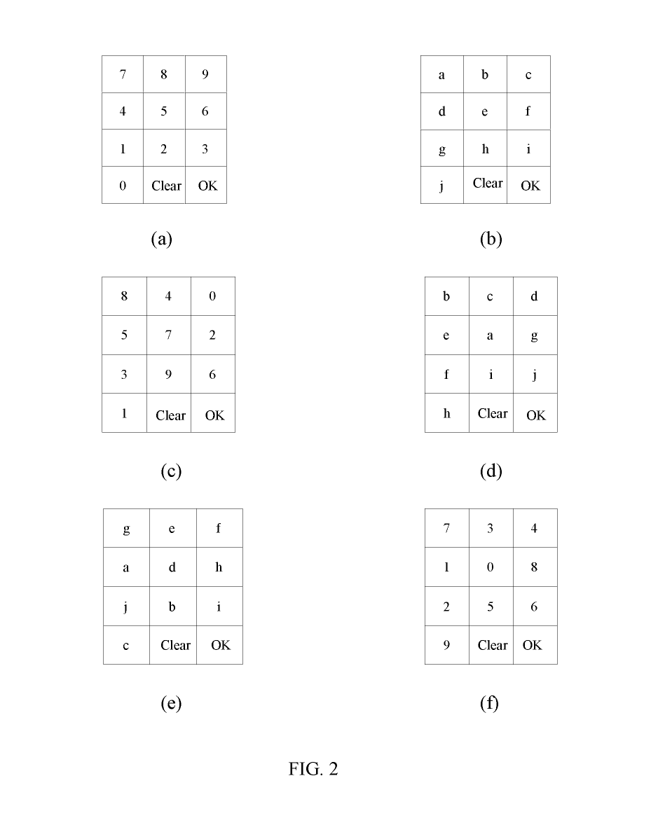

As shown in FIG. 1, an ATM machine is illustrated. FIG. 2(a) is an input keypad of the ATM machine allowing input of numbers 0 to 9. As shown in FIG. 2(b), ten alphabets a to j are used as intermediate symbols. Assuming the password of a user is ‘123941’, results obtained after the first-stage association relationship is created are displayed on a screen of the ATM machine, as shown in FIGS. 2(c) and 2(d), and results obtained after the second-stage association relationship are displayed on the screen thereof, as shown in FIGS. 2(e) and 2(f). If the user wants to input a number ‘1’, firstly an intermediate symbol ‘a’ corresponding to the number ‘1’ in the second-stage association relationship in FIGS. 2(e) and 2(f) is to be found, an original symbol ‘7’ corresponding to the intermediate symbol ‘a’ in the first-stage association relationship in FIGS. 2(c) and 2(d) is to be found, and finally the user is required to input a number ‘7’ on the keypad of the ATM machine If the user then wants to input a number ‘2’, two new association relationships are created, and the same principle as above applies. For the purpose of easy illustration and understanding, it is assumed that the association relationship in each of the following five times of input is the same as that in the first time, then finally password symbols input by the user should be ‘765437’. Parsing of all password symbols input by the user on the ATM machine is an inverse process of the above-mentioned password input method, and comprises determining final original symbols according to the first-stage association relationship and the second-stage association relationship.

### Example 2

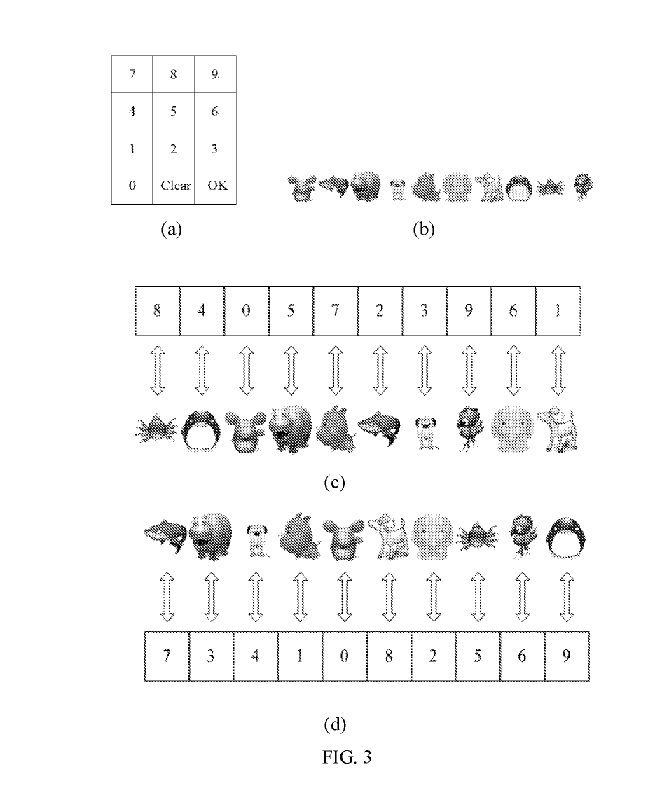

FIG. 3(a) is an input keypad of the ATM machine allowing input of numbers 0 to 9. As shown in FIG. 3(b), ten animal patterns are used as intermediate symbols. Assuming a password of a user is ‘123941’, results obtained after the first-stage association relationship is created are displayed on a screen of the ATM machine, as shown in FIG. 3(c), and results obtained after the second-stage association relationship are displayed on the screen thereof, as shown in FIG. 3(d). If the user wants to input a number ‘1’, firstly an intermediate symbol corresponding to the number ‘1’ in the second-stage association relationship in FIG. 3(d) is to be found, an original symbol ‘7’ corresponding to the intermediate symbol in the first-stage association relationship in FIG. 3(c) is to be found, and finally the user is required to input a number ‘7’ on the keypad of the ATM machine If the user then wants to input a number ‘2’, two new association relationships are created, and the same principle as above applies. For the purpose of easy illustration and understanding, it is assumed that the association relationship in each of the following five times of input is the same as that in the first time, then finally password symbols input by the user should be ‘765437’.

### Example 3

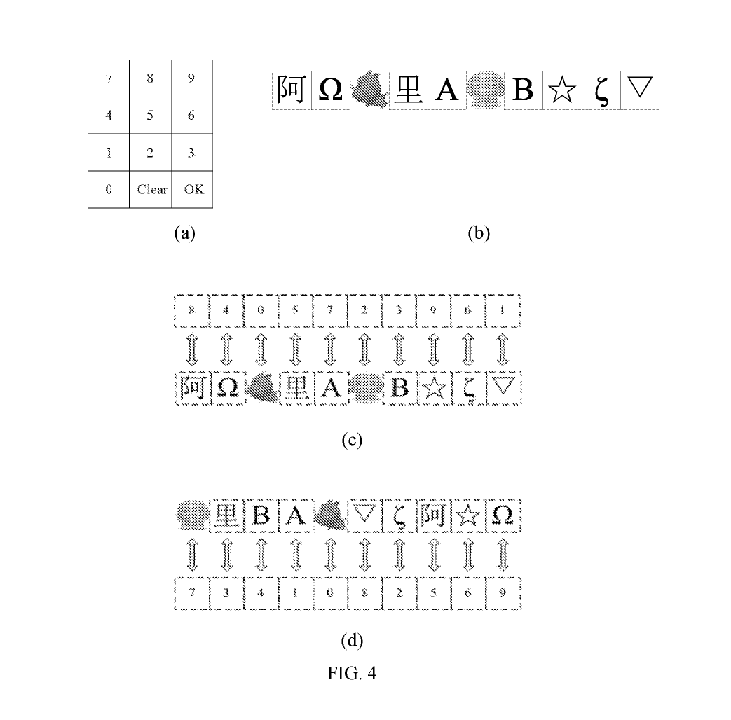

FIG. 4(a) is an input keypad of the ATM machine allowing input of numbers 0 to 9. As shown in FIG. 4(b), combinations of texts, alphabets, and graphs are used as intermediate symbols. Assuming a password of a user is ‘123941’, results obtained after the first-stage association relationship is created are displayed on a screen of the ATM machine, as shown in FIG. 4(c), and results obtained after the second-stage association relationship are displayed on the screen thereof, as shown in FIG. 4(d). If the user wants to input a number ‘1’, firstly an intermediate symbol ‘A’ corresponding to the number ‘1’ in the second-stage association relationship in FIG. 4(d) is to be found, an original symbol ‘7’ corresponding to the intermediate symbol ‘A’ in the first-stage association relationship in FIG. 3(c) is to be found, and finally the user is required to input a number ‘7’ on the keypad of the ATM machine If the user then wants to input a number ‘2’, two new association relationships are created, and the same principle as above applies. For the purpose of easy illustration and understanding, it is assumed that the association relationship in each of the following five times of input is the same as that in the first time, then finally password symbols input by the user should be ‘765437’.

While preferred embodiments of the invention have been described above, the invention is not limited to disclosure in the embodiments and the accompanying drawings. Any changes or modifications without departing from the spirit of the invention fall within the scope of the invention.

1. A password input method based on two-stage association, comprising steps of:
(1) providing multiple password symbols as original symbols, and randomly creating intermediate symbols with the same number therewith;
(2) randomly ordering said original symbols and said intermediate symbols, and associating each ordered original symbol with respective ordered intermediate symbol based on spatial positions thereof, thereby creating first-stage association relationship;
(3) randomly re-ordering said original symbols and said intermediate symbols, and re-associating each re-ordered original symbol with respective re-ordered intermediate symbol based on spatial positions thereof, thereby creating second-stage association relationship;
(4) inputting a current password symbol by firstly searching for an intermediate symbol corresponding thereto in said second-stage association relationship, obtaining an original symbol corresponding to said intermediate symbol in said first-stage association relationship, and inputting said obtained original symbol; and
(5) repeating steps (2) to (4) until input of all password symbols is completed.

2. The password input method of claim 1, wherein said original symbol is one of an alphabet, a number, a special character, a Chinese character, a graph, an image, or a combination thereof.

3. The password input method of claim 1, wherein said intermediate symbol is one of an alphabet, a number, a special character, a Chinese character, a graph, an image, or a combination thereof.

4. The password input method of claim 1, wherein said original symbol is different from said intermediate symbol.

5. The password input method of claim 1, wherein said original symbol is an alphabet, a number, or a combination thereof, and said intermediate symbol is a special character, a graph, an image, or a combination thereof.

6. The password input method of claim 1, wherein each of said first-stage association relationship and said second-stage association relationship is formed in a manner of a sequence or a matrix.

7. A password input system based on two-stage association, comprising:
a first module configured to provide multiple password symbols as original symbols, and to randomly create intermediate symbols with the same number therewith;
a second module configured to randomly order said original symbols and said intermediate symbols, and to associate each ordered original symbol with respective ordered intermediate symbol based on spatial positions thereof, thereby creating first-stage association relationship;
a third module configured to randomly re-order said original symbols and said intermediate symbols, and to re-associate each re-ordered original symbol with respective re-ordered intermediate symbol based on spatial positions thereof, thereby creating second-stage association relationship;
a fourth module configured to input a current password symbol by firstly searching for an intermediate symbol corresponding thereto in said second-stage association relationship, to obtain an original symbol corresponding to said intermediate symbol in said first-stage association relationship, and to input said obtained original symbol; and
a fifth module configured to repeat said second modules to said fourth modules, until input of all password symbols is completed.
